(19) United States
(12) Patent Application Publication
(10) Pub. No.: US 2024/0205758 A1
(43) Pub. Date: Jun. 20, 2024

(54) Method and Apparatus for Handover Management

(71) Applicant: Telefonaktiebolaget LM Ericsson (pub), Stockholm (SE)

(72) Inventors: Wenming Chen, Shanghai (CN); Juying Gan, Shanghai (CN); Yong Yang, Kållered (SE); Qiong Song, Shanghai (CN); Lei Xia, Shanghai (CN); Xuemei Zhang, Shanghai (CN); Yunjie Lu, Shanghai (CN); Xiaoming Li, Shanghai (CN); Ce Zhang, Shanghai (CN)

(21) Appl. No.: 18/555,590

(22) PCT Filed: May 9, 2022
(86) PCT No.: PCT/EP2022/062435

§ 371 Date: Oct. 16, 2023

(30) Foreign Application Priority Data
May 11, 2021 (WO) PCT/CN2021/093133

(51) Int. Cl. H04W 36/00

(52) U.S. Cl. CPC H04W 36/00226; H04W 36/0033

(57) ABSTRACT

Embodiments of the present disclosure provide method and apparatus for handover management. A method performed by a first mobility management function in a first system comprises obtaining mobility management context for single radio voice call continuity (SRVCC). The method further comprises sending a forward relocation request to a second mobility management function in a second system during a handover from the first system to the second system. The forward relocation request comprises mobility management context for the SRVCC.

### TECHNICAL FIELD

The non-limiting and exemplary embodiments of the present disclosure generally relate to the technical field of communications, and specifically to methods and apparatuses for handover management.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example NR (new radio) as defined by 3rd Generation Partnership Project (3GPP), a handover (HO) procedure may be used to hand over a terminal device such as user equipment (UE) from a communication network to another communication network. Clause 4.11 of 3GPP TS 23.502 V17.0.0, the disclosure of which is incorporated by reference herein in its entirety, describes various handover procedures, such as 5GS (fifth generation system) to EPS (Evolved Packet System) handover using N26 interface, etc. 3GPP TS 23.401 V17.0.0, the disclosure of which is incorporated by reference herein in its entirety, describes various handover procedures, such as E-UTRAN (Evolved Universal Terrestrial Radio Access Network) to UTRAN (Universal Terrestrial Radio Access Network) Iu mode Inter RAT (Radio Access Technology) handover, E-UTRAN to GERAN (GSM (Global System for Mobile communications) EDGE (Enhanced Data rates for GSM Evolution) Radio Access Network) A/Gb mode Inter RAT handover, etc.

3GPP TS 23.216 V16.4.0, the disclosure of which is incorporated by reference herein in its entirety, describes Single Radio Voice Call Continuity (SRVCC). SRVCC denotes voice call continuity between IMS (IP (Internet protocol) Multimedia Subsystem) over PS (Packet Switched) access and CS (Circuit Switched) access for calls that are anchored in IMS when the UE (user equipment) is capable of transmitting/receiving on only one of those access networks at a given time. SRVCC provides an interim solution for handing over VOLTE (voice over LTE) to 2G/3G (second generation/third generation) networks, and it requires support of UE subscription, UE capability and Network capability.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be some issues for a case of 5G to 4G handover and then 4G to 2G/3G SRVCC. 3GPP TS 29.274 V17.1.1, the disclosure of which is incorporated by reference herein in its entirety, has introduced an IE (information element) “Additional MM (Mobility Management) Context for SRVCC” which contains mobile station classmark(s) and supported codec list, to facilitate the SRVCC HO that occurs immediately after the PS HO, during UE moves from a first MME (Mobility Management Entity) to a second MME, and continues to move from the second MME to a target SGSN/MSC (Serving GPRS (General Packet Radio Service) Support Node/Mobile Switching Centre). In brief, the IE “Additional MM Context for SRVCC” enables MME/SGSN to build a SRVCC PS to CS request message correctly before the TAU (Tracking Area Update) procedure in the second MME. Thus, the IE “Additional MM Context for SRVCC” helps on passing the SRVCC capability between the source nodes and target nodes in some cases such as the case of 4G (fourth generation) to 4G handover and then 4G to 2G/3G SRVCC, or the case of 4G to 2G/3G SRVCC.

As 5G (fifth generation) roll out, 3GPP TS 29.274 V17.1.1 was updated to specify the enhancements for SRVCC, especially for a direct 5G to 2G SRVCC case, or a direct 5G to 3G SRVCC case, in which MME serves as a control plane relay between AMF (Access Mobility Management Function) and MSC, namely MME_SRVCC.

As described in the clause 2.1 of 3GPP TS 29.274 V17.1.1, it already considers a case of 4G to 4G handover and then 4G to 2G/3G SRVCC. However, the similar case of 5G to 4G handover and then 4G to 2G/3G SRVCC is not mentioned or considered in the SRVCC procedures as described in 3GPP TS 23.216 V16.4.0. As a result, the whole SRVCC procedure is not complete across 2G/3G/4G/5G, which causes issues for the 5G to 4G handover and then 4G to 2G/3G SRVCC, and also causes confusion for implementation.

In the 5G SRVCC of 3GPP TS 23.216 V16.4.0, a new “MME_SRVCC” is defined and it plays a pure control plane relay role between the MSC and AMF, and UE is agnostic to the existence of MME during the direct 5G to 2G/3G SRVCC procedure. However to support the above case of 5G to 4G handover and 4G to 2G/3G SRVCC, it is not enough for MME to only act as the control plane relay.

In 3GPP TS 23.216 V16.4.0, UE is described to include only Mobile Station Classmark2 and Supported Codecs IE in the registration request to AMF. But the Mobile Station Classmark3 is not mentioned at all. When Mobile Station Classmark3 and Supported Codec List case is excluded, it may cause issues for the 5G to 4G handover and then 4G to 2G/3G SRVCC.

In the clause 6.1.6 of 3GPP TS 29.503 V17.2.0, the disclosure of which is incorporated by reference herein in its entirety, it mentions the session transfer number for SRVCC (STN-SR) or correlation mobile subscriber integrated services digital network number (C-MSISDN) are included only when UE subscribes to 5G SRVCC, which causes issues for the 5G to 4G handover and then 4G to 2G/3G SRVCC, and also causes confusion for vendors' implementation.

FIG. 1 shows a flowchart of 5GS to EPS handover for single-registration mode with N26 interface, which is the same as FIG. 4.11.1.2.1-1 of 3GPP TS 23.502 V17.0.0, the disclosure of which is incorporated by reference herein in its entirety.

At step 3 of FIG. 1, the AMF sends a Forward Relocation Request (FRR) as in step 3 in clause 5.5.1.2.2 (S1-based handover, normal) in 3GPP TS 23.401 V17.0.0, with the following modifications and clarifications:
Parameter “Return preferred” may be included. Return preferred is an optional indication by the MME of a preferred return of the UE to the 5GS PLMN at a later access change to a 5GS shared network. An MME may use this information as specified by 3GPP TS 23.501 V17.0.0.
The Serving gateway (SGW) address and TEID (Tunnel End Point Identifier) for both the control-plane or EPS bearers in the message are such that target MME selects a new SGW.
The AMF determines, based on configuration and the Direct Forwarding Path Availability, the Direct Forwarding Flag to inform the target MME whether direct data forwarding is applicable.
The AMF includes the mapped SM (Session Management) EPS UE Contexts for PDU (Protocol Data Unit) Sessions with and without active UP (user plane) connections.
Subject to operator policy if the secondary RAT access restriction condition is the same for EPS and 5GS, the AMF may set EPS secondary RAT access restriction condition based on the UE's subscription data.

Since AMF doesn't include the “Additional MM context for SRFVCC” in the FRR at step 3 of FIG. 1, MME has no knowledge whether UE is SRVCC capable, thus MME cannot send a handover request including a SRVCC Operation Possible indication to E-UTRAN at step 6 of FIG. 1.

At step 18 of FIG. 1, the UE initiates a Tracking Area Update (TAU) procedure as specified in step 18 of clause 5.5.1.2.2 (S1-based handover, normal) in 3GPP TS 23.401 V17.0.0.

Per 3GPP TS 23.502 V17.0.0 clause 4.11.1.2.1, the SRVCC cannot be triggered until step 18. When MME receives the MS (Mobile Station) Network Capability in the TAU Request message and after the MME sends the SRVCC Operation Possible indication to the E-UTRAN, then the SRVCC can be triggered. Therefore the SRVCC HO cannot be triggered immediately after the 5GS to EPS handover for single-registration mode with N26 interface.

To overcome or mitigate at least one of above mentioned problems or other problems, the embodiments of the present disclosure propose an improved solution for handover management.

In a first aspect of the disclosure, there is provided a method performed by a first mobility management function in a first system. The method comprises obtaining mobility management context for single radio voice call continuity (SRVCC). The method further comprises sending a forward relocation request to a second mobility management function in a second system during a handover from the first system to the second system. The forward relocation request comprises mobility management context for the SRVCC.

In an embodiment, the first system is a fifth generation system (5GS) and the second system is an evolved packet system (EPS).

In an embodiment, the handover from the first system to the second system is 5GS to EPS handover using N26 interface.

In an embodiment, the forward relocation request further comprises at least one of session transfer number for SRVCC (STN-SR) or correlation mobile subscriber integrated services digital network number (C-MSISDN).

In an embodiment, the forward relocation request further comprises at least one of session transfer number for SRVCC (STN-SR) or correlation mobile subscriber integrated services digital network number (C-MSISDN) when a user equipment related to the handover is subscribed to second system SRVCC.

In an embodiment, the mobility management context for the SRVCC comprises information necessary for the second mobility management function to perform SRVCC.

In an embodiment, the information comprises at least one mobile station classmark and/or supported codec list of a user equipment related to the handover.

In an embodiment, the first mobility management function comprises an access and mobility function (AMF) and the second mobility management function comprises a mobility management entity (MME).

In a second aspect of the disclosure, there is provided a method performed by a second mobility management function in a second system. The method comprises receiving a forward relocation request from a first mobility management function in a first system during a handover from the first system to the second system. The forward relocation request comprises mobility management context for single radio voice call continuity (SRVCC). The method further comprises determining a SRVCC operation possible indication indicating whether both a user equipment and the second mobility management function are SRVCC-capable based at least partly on the mobility management context for SRVCC. The method further comprises sending a handover request message comprising the SRVCC operation possible indication to an access network node in the second system.

In a third aspect of the disclosure, there is provided a method performed by an access network node in a second system. The method comprises receiving a handover request message comprising a single radio voice call continuity (SRVCC) operation possible indication indicating whether both a user equipment and a second mobility management function in a second system are SRVCC-capable from the second mobility management function in the second system during a handover from a first system to the second system. The method further comprises triggering SRVCC from the second system to a third system after the handover from the first system to the second system based on the SRVCC operation possible indication.

In an embodiment, triggering SRVCC from the second system to a third system after the handover from the first system to the second system based on the SRVCC operation possible indication comprising immediately triggering SRVCC from the second system to the third system after the handover from the first system to the second system based on the SRVCC operation possible indication.

In an embodiment, the first system is a fifth generation system (5GS), the second system is an evolved packet system (EPS), and the third system is a second generation system or a third generation system.

In an embodiment, the second mobility management function comprises a mobility management entity (MME).

In a fourth aspect of the disclosure, there is provided a first mobility management function in a first system. The first mobility management function comprises a processor and a memory coupled to the processor. Said memory contains instructions executable by said processor. Said first mobility management function is operative to obtain mobility management context for single radio voice call continuity (SRVCC). Said first mobility management function is further operative to send a forward relocation request to a second mobility management function in a second system during a handover from the first system to the second system. The forward relocation request comprises mobility management context for the SRVCC.

In a fifth aspect of the disclosure, there is provided a second mobility management function in a second system. The second mobility management function comprises a processor and a memory coupled to the processor. Said memory contains instructions executable by said processor. Said second mobility management function is operative to receive a forward relocation request from a first mobility management function in a first system during a handover from the first system to the second system. The forward relocation request comprises mobility management context for single radio voice call continuity (SRVCC). Said second mobility management function is further operative to determine a SRVCC operation possible indication indicating whether both a user equipment and the second mobility management function are SRVCC-capable based at least partly on the mobility management context for SRVCC. Said second mobility management function is further operative to send a handover request message comprising the SRVCC operation possible indication to an access network node in the second system.

In a sixth aspect of the disclosure, there is provided an access network node in a second system. The access network node comprising a processor and a memory coupled to the processor. Said memory contains instructions executable by said processor. Said access network node is operative to receive a handover request message comprising a single radio voice call continuity (SRVCC) operation possible indication indicating whether both a user equipment and a second mobility management function in a second system are SRVCC-capable from the second mobility management function in the second system during a handover from a first system to the second system. Said access network node is further operative to trigger SRVCC from the second system to a third system after the handover from the first system to the second system based on the SRVCC operation possible indication.

In a seventh aspect of the disclosure, there is provided a first mobility management function in a first system in a first system. The first mobility management function comprises an obtaining module configured to obtain mobility management context for single radio voice call continuity (SRVCC). The first mobility management function further comprises a sending module configured to send a forward relocation request to a second mobility management function in a second system during a handover from the first system to the second system. The forward relocation request comprises mobility management context for the SRVCC.

In an eighth aspect of the disclosure, there is provided a second mobility management function in a second system. The second mobility management function comprises a receiving module configured to receive a forward relocation request from a first mobility management function in a first system during a handover from the first system to the second system. The forward relocation request comprises mobility management context for single radio voice call continuity (SRVCC). The second mobility management function further comprises a determining module configured to determine a SRVCC operation possible indication indicating whether both a user equipment and the second mobility management function are SRVCC-capable based at least partly on the mobility management context for SRVCC. The second mobility management function further comprises a sending module configured to send a handover request message comprising the SRVCC operation possible indication to an access network node in the second system.

In a ninth aspect of the disclosure, there is provided a block diagram showing an access network node in a second system. As shown, the access network node comprises a receiving module configured to receive a handover request message comprising a single radio voice call continuity (SRVCC) operation possible indication indicating whether both a user equipment and a second mobility management function in a second system are SRVCC-capable from the second mobility management function in the second system during a handover from a first system to the second system. The access network node further comprises a triggering module configured to trigger SRVCC from the second system to a third system after the handover from the first system to the second system based on the SRVCC operation possible indication.

In a tenth aspect of the disclosure, there is provided a computer program product comprising instructions which when executed by at least one processor, cause the at least one processor to perform the method according to any one of the first, second and third aspects.

In an eleventh aspect of the disclosure, there is provided a computer-readable storage medium storing instructions which when executed by at least one processor, cause the at least one processor to perform the method according to any one of the first, second and third aspects.

Embodiments herein may provide many advantages, of which a non-exhaustive list of examples follows. In some embodiments herein, it proposed a solution for the case of 5G to 4G Handover and then 4G to 2G/3G SRVCC. This user case is missed in 3GPP TS 23.216 V16.4.0. In some embodiments herein, the new IEs “4gStnSr” and “4gcMsisdn” are added in the section 6.1.6 Data Model of 3GPP TS 29.503 V17.2.0 which can be used for the proposed solution. In some embodiments herein, the MS Classmark3 and Supported Codec List, indicating GERAN access is supported by UE, can be sent in the FRR from AMF to MME, which can be used in some SRVCC cases. In some embodiments herein, the proposed solution extends the user case of SRVCC in which UE moves in this way: 5G->4G(Handover)->2G/3G(SRVCC). In some embodiments herein, the proposed solution can save the SRVCC procedure time since the SRVCC procedure can be immediately performed after the handover has completed. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of 5GS to EPS handover for single-registration mode with N26 interface;

FIG. 2 schematically shows a high level architecture in the fifth generation network according to an embodiment of the present disclosure;

FIG. 3 schematically shows a high level architecture in the fourth generation network according to an embodiment of the present disclosure;

FIG. 4 schematically shows home-routed roaming architecture for interworking between 5GS and EPC/E-UTRAN;

FIG. 5 shows a flowchart of a method according to an embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of 5GS to EPS handover using N26 interface with enhancements for SRVCC according to an embodiment of the present disclosure;

FIG. 9 is a block diagram showing an apparatus suitable for practicing some embodiments of the disclosure;

FIG. 10 is a block diagram showing a first mobility management function in a first system according to an embodiment of the disclosure;

FIG. 11 is a block diagram showing a second mobility management function in a second system according to an embodiment of the disclosure; and

FIG. 12 is a block diagram showing an access network node in a second system according to an embodiment of the disclosure.

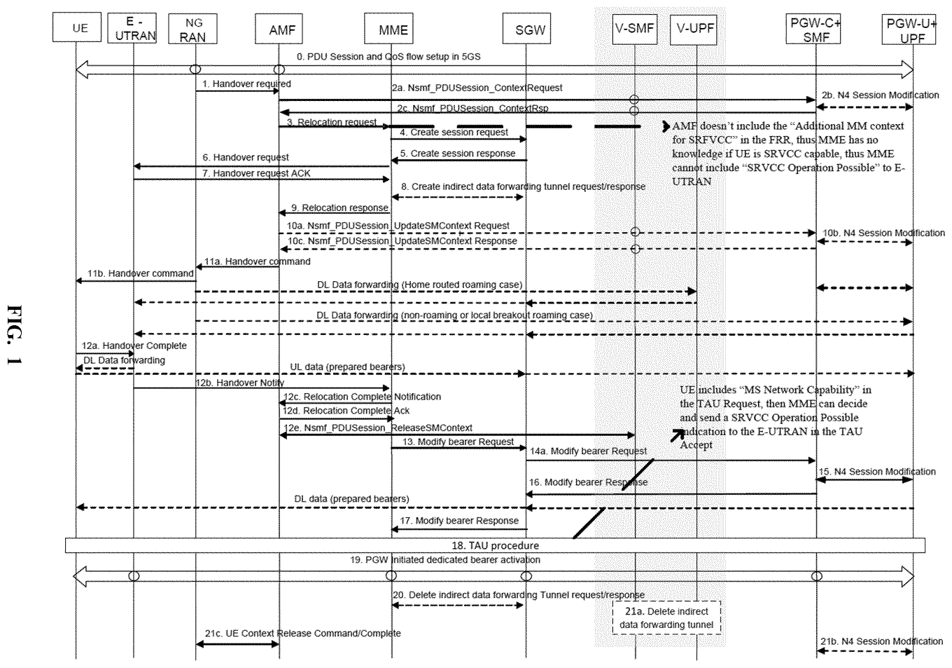

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable network entity which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobility management entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IOT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

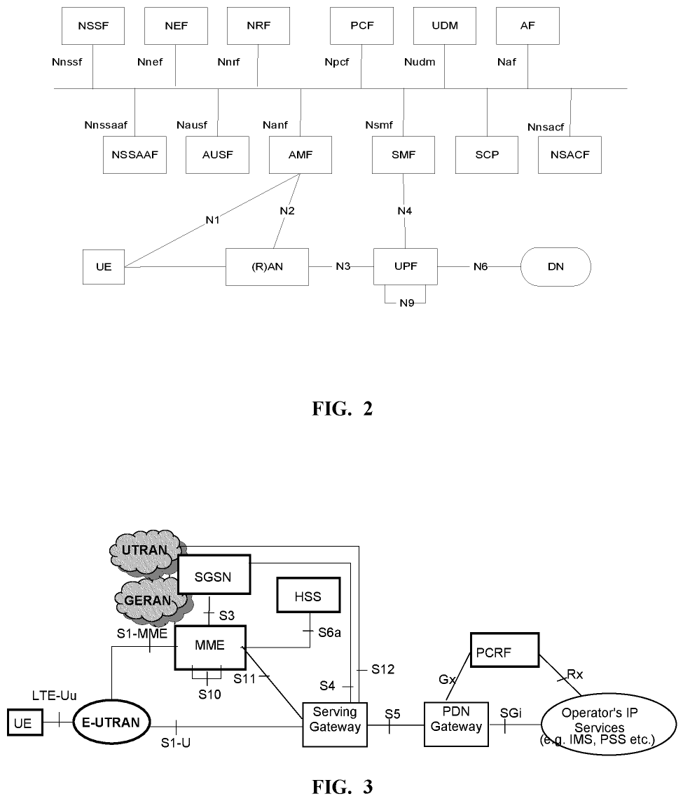

Although the subject matter described herein may be implemented in any appropriate type of system using any suitable components, the embodiments disclosed herein are described in relation to a communication system complied with the exemplary system architectures illustrated in FIGS. 2-4. For simplicity, the system architectures of FIGS. 2-4 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

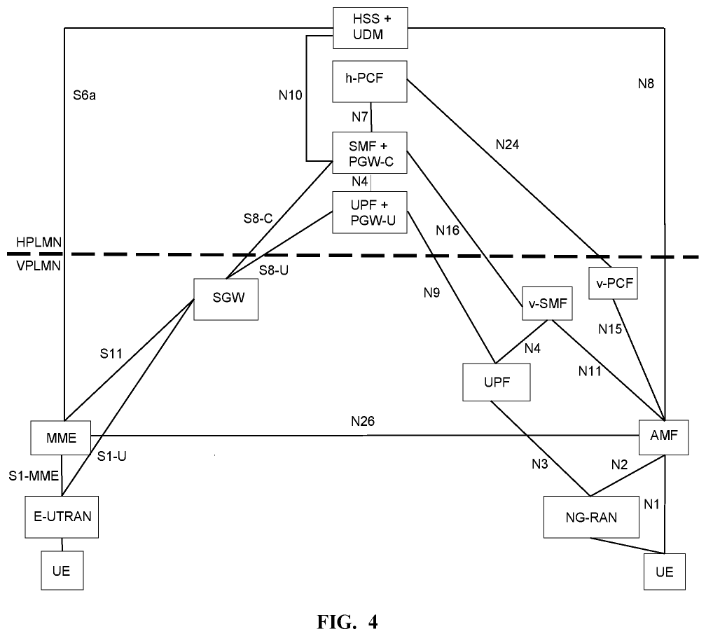

FIG. 2 schematically shows a high level architecture in the fifth generation network according to an embodiment of the present disclosure. For example, the fifth generation network may be 5GS. The architecture of FIG. 2 is same as FIG. 4.2.3-1 as described in 3GPP TS 23.501 V17.0.0, the disclosure of which is incorporated by reference herein in its entirety. The system architecture of FIG. 2 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc. PSS denotes packet-switched streaming service.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 2 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.0.0.

FIG. 3 schematically shows a high level architecture in the fourth generation network according to an embodiment of the present disclosure, which is the same as FIG. 4.2.1-1 of 3GPP TS 23.401 V17.0.0. The system architecture of FIG. 3 may comprise some exemplary elements such as UTRAN, GERAN, SGSN, MME, HSS (Home Subscriber Server), E-UTRAN, serving gateway, PDN (Packet Data Network) gateway, PCRF (Policy and Charging Rules Function), etc.

There are some reference points as shown in FIG. 3.

S1-MME: Reference point for the control plane protocol between E-UTRAN and MME.

S1-U: Reference point between E-UTRAN and Serving GW (gateway) for the per bearer user plane tunnelling and inter eNodeB path switching during handover. S1-U does not apply to the Control Plane CIoT (Cellular Internet of Things) EPS Optimisation.

S3: It enables user and bearer information exchange for inter 3GPP access network mobility in idle and/or active state. This reference point can be used intra-PLMN or inter-PLMN (e.g. in the case of Inter-PLMN (Public Land Mobile Network) HO).

S4: It provides related control and mobility support between GPRS Core and the 3GPP Anchor function of Serving GW. In addition, if Direct Tunnel is not established, it provides the user plane tunnelling.

S5: It provides user plane tunnelling and tunnel management between Serving GW and PDN GW. It is used for Serving GW relocation due to UE mobility and if the Serving GW needs to connect to a non-collocated PDN GW for the required PDN connectivity.

S6a: It enables transfer of subscription and authentication data for authenticating/authorizing user access to the evolved system (AAA (Authentication, Authorization, Accounting) interface) between MME and HSS.

Gx: It provides transfer of (QOS) policy and charging rules from PCRF to Policy and Charging Enforcement Function (PCEF) in the PDN GW.

S11: Reference point providing control plane between MME and Serving GW. In addition, in order to support Control Plane CIoT EPS Optimisation, the S11-U reference point provides user plane between MME and Serving GW.

S12: Reference point between UTRAN and Serving GW for user plane tunnelling when Direct Tunnel is established. It is based on the Iu-u/Gn-u reference point using the GTP-U (GPRS Tunnelling Protocol for User Plane) protocol as defined between SGSN and UTRAN or respectively between SGSN and GGSN. Usage of S12 is an operator configuration option.

SGi: It is the reference point between the PDN GW and the packet data network. Packet data network may be an operator external public or private packet data network or an intra operator packet data network, e.g. for provision of IMS services. This reference point corresponds to Gi for 3GPP accesses.

Rx: The Rx reference point resides between the AF (application function) and the PCRF.

The network elements and reference points as shown in FIG. 3 may be same as the corresponding network elements and reference point as described in 3GPP TS 23.401 V17.0.0.

FIG. 4 schematically shows home-routed roaming architecture for interworking between 5GS and EPC (Evolved Packet Core)/E-UTRAN (Evolved Universal Terrestrial Radio Access Network), which is the same as FIG. 4.3.2-2 of 3GPP TS 23.501 V17.0.0. The system architecture of FIG. 4 may comprise some exemplary elements such as HSS (Home Subscriber Server)+UDM (HSS combined with UDM), h-PCF (home PCF), SMF+PGW-C(SMF combined with PGW-C), UPF+PGW-U (PGW user plane) (UPF combined with PGW-U), SGW, v-SMF (visited SMF), v-PCF (visited PCF), UPF, MME, AMF, E-UTRAN, NG-RAN, UE, etc. The network elements and reference points as shown in FIG. 4 may be same as the corresponding network elements and reference points as described in 3GPP TS 23.501 V17.0.0.

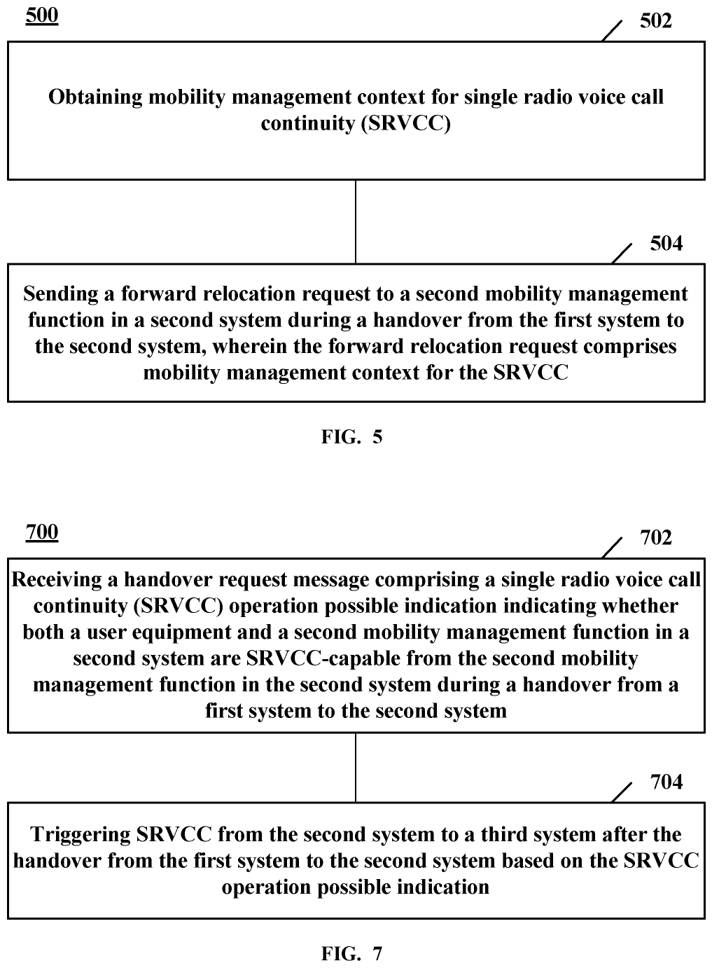

FIG. 5 shows a flowchart of a method according to an embodiment of the present disclosure, which may be performed by an apparatus implemented in or at or as a first mobility management function in a first system or communicatively coupled to the first mobility management function in the first system. As such, the apparatus may provide means or modules for accomplishing various parts of the method 500 as well as means or modules for accomplishing other processes in conjunction with other components. The first mobility management function may be any suitable network device or node or entity or function which can provide mobility management function. For example, the first mobility management function may be AMF of 5GS. The first system may be any suitable communication system such as 5GS.

At block 502, the first mobility management function may obtain mobility management context for single radio voice call continuity (SRVCC). The mobility management context for SRVCC may be the mobility management context for SRVCC for a UE to be or being handed over from the first system to a second system. In an embodiment, the mobility management context for SRVCC may be the Additional MM context for SRVCC as described in 3GPP TS 29.274 V17.1.1. The first mobility management function may obtain mobility management context for SRVCC in various ways. For example, when the first mobility management function has stored the mobility management context for SRVCC, it may locally obtain the mobility management context for SRVCC. When the mobility management context for SRVCC is stored in another network function (such as in UE Registration and Subscription data of UDM), the first mobility management function may obtain the mobility management context for SRVCC by retrieving the mobility management context for SRVCC from another network function. The first mobility management function may obtain the mobility management context for SRVCC from another network function (such as another mobility management function) when another network function sends the mobility management context for SRVCC to the first mobility management function by.

In an embodiment, when the first mobility management function receives a handover required message from an access network node of the first system and determines for example from a target access network node identifier comprised in the handover required message that the type of handover is handover to a second system, the first mobility management function may obtain the mobility management context for SRVCC.

At block 504, the first mobility management function may send a forward relocation request to a second mobility management function in a second system during a handover from the first system to the second system. The forward relocation request comprises mobility management context for the SRVCC. The second mobility management function may be any suitable network device or node or entity or function which can provide mobility management function. For example, the second mobility management function may be MME of EPS. The second system may be any suitable communication system such as EPS.

In an embodiment, the mobility management context for the SRVCC (such as Additional MM context for SRVCC) shall be sent by the first mobility management function such as source AMF to the second mobility management function such as target MME_SRVCC on the N26 interface if the mobility management context for the SRVCC are available in the first mobility management function such as source AMF.

In an embodiment, the first system is a fifth generation system (5GS) and the second system is an evolved packet system (EPS).

In an embodiment, the handover from the first system to the second system is 5GS to EPS handover using N26 interface as described in 3GPP TS 23.502 V17.0.0.

In an embodiment, the forward relocation request may comprise any suitable information necessary for the handover from the first system to the second system and any suitable information necessary for the second mobility management function to perform SRVCC.

In an embodiment, the forward relocation request further comprises at least one of session transfer number for SRVCC (STN-SR) or correlation mobile subscriber integrated services digital network number (C-MSISDN). For example, the STN-SR shall be present if the STN-SR is available in the first mobility management function or the UE is subscribed to SRVCC. When present, it indicates the STN-SR of the UE. The first mobility management function such as AMF can inform the second mobility management function such as MME that UE has SRVCC capability via the FRR. For example, the C-MSISDN shall be present if the C-MSISDN is available in the first mobility management function or the UE is subscribed to SRVCC. When present, it indicates the C-MSISDN of the UE. The first mobility management function such as AMF can inform the second mobility management function such as MME that UE has SRVCC capability via the FRR.

In an embodiment, the forward relocation request further comprises at least one of session transfer number for SRVCC (STN-SR) or correlation mobile subscriber integrated services digital network number (C-MSISDN) when a user equipment related to the handover is subscribed to second system SRVCC. For example, the STN-SR shall be present the UE is subscribed to second system SRVCC. When present, it indicates the STN-SR of the UE. The first mobility management function such as AMF can inform the second mobility management function such as MME that UE has second system SRVCC capability via the FRR. For example, the C-MSISDN shall be present if the UE is subscribed to second system SRVCC. When present, it indicates the C-MSISDN of the UE. The first mobility management function such as AMF can inform the second mobility management function such as MME that UE has second system SRVCC capability via the FRR.

In an embodiment, the mobility management context for the SRVCC comprises information necessary for the second mobility management function to perform SRVCC.

In an embodiment, information necessary for the second mobility management function to perform SRVCC comprises at least one mobile station classmark and/or supported codec list of a user equipment related to the handover. For example, the mobile station classmark and/or the supported codec list may be same as the Mobile Station Classmark and/or supported codec list as described in 3GPP TS 24.008 V17.2.0, the disclosure of which is incorporated by reference herein in its entirety. For example, the GERAN MS Classmark 3 may be included if GERAN access is supported. The MS Classmark 2 may be included if GERAN or UTRAN access or both are supported.

In an embodiment, the mobility management context for the SRVCC such as Additional MM context for SRVCC shall be sent by the first mobility management function such as source AMF to the second mobility management function such as target MME_SRVCC on the N26 interface if MS Classmark2/3 and the Supported Codec are available in the first mobility management function such as source AMF.

In an embodiment, the first mobility management function comprises an access and mobility function (AMF) and the second mobility management function comprises a mobility management entity (MME).

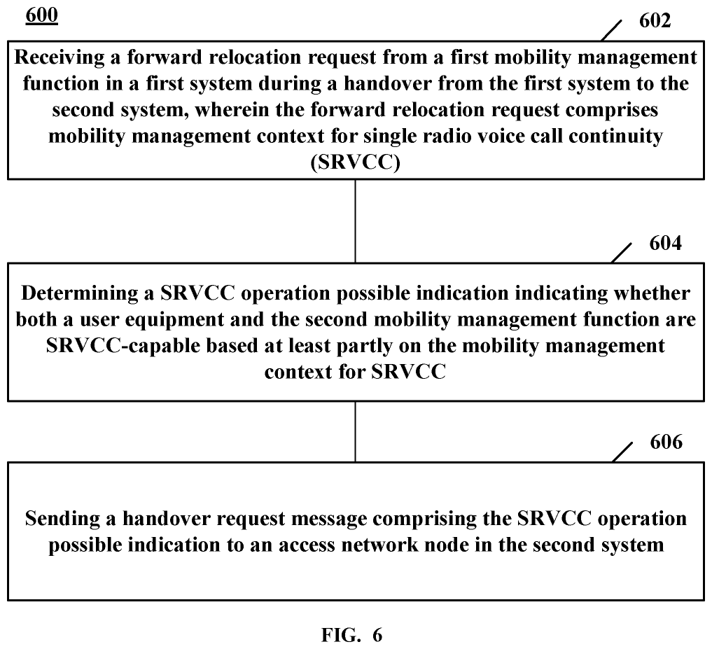

FIG. 6 shows a flowchart of a method according to another embodiment of the present disclosure, which may be performed by an apparatus implemented in or at or as a second mobility management function in the second system or communicatively coupled to the second mobility management function in the second system. As such, the apparatus may provide means or modules for accomplishing various parts of the method 600 as well as means or modules for accomplishing other processes in conjunction with other components. The second mobility management function may be any suitable network device or node or entity or function which can provide mobility management function. For example, the first mobility management function may be MME of EPS. The second system may be any suitable communication system such as EPS. For some parts which have been described in the above embodiments, the description thereof is omitted here for brevity.

At block 602, the second mobility management function may receive a forward relocation request from a first mobility management function in a first system during a handover from the first system to the second system. The forward relocation request comprises mobility management context for single radio voice call continuity (SRVCC). For example, the first mobility management function may send the forward relocation request to the second mobility management function during a handover from the first system to the second system at block 504 of FIG. 5, and then the second mobility management function may receive the forward relocation request from the first mobility management function.

At block 604, the second mobility management function may determine a SRVCC operation possible indication indicating whether both a user equipment and the second mobility management function are SRVCC-capable based at least partly on the mobility management context for SRVCC. The second mobility management function may know whether the user equipment is SRVCC-capable based on based on the mobility management context for SRVCC. For example, based on the MS Classmark and Supported Codec information from the Additional MM context for SRVCC in FRR, the second mobility management function such as MME determines whether the user equipment is SRVCC-capable.

At block 606, the second mobility management function may send a handover request message comprising the SRVCC operation possible indication to an access network node in the second system.

FIG. 7 shows a flowchart of a method according to another embodiment of the present disclosure, which may be performed by an apparatus implemented in or at or as an access network node in the second system or communicatively coupled to the an access network node in the second system. As such, the apparatus may provide means or modules for accomplishing various parts of the method 700 as well as means or modules for accomplishing other processes in conjunction with other components. The access network node may be any suitable network device or node or entity or function which can provide access function. For example, the access network node may be E-UTRAN of EPS. The second system may be any suitable communication system such as EPS. For some parts which have been described in the above embodiments, the description thereof is omitted here for brevity.

At block 702, the access network node may receive a handover request message comprising a single radio voice call continuity (SRVCC) operation possible indication indicating whether both a user equipment and a second mobility management function in a second system are SRVCC-capable from the second mobility management function in the second system during a handover from a first system to the second system. For example, the second mobility management function may send the handover request message comprising the SRVCC operation possible indication to the access network node in the second system at block 606 of FIG. 6, and then the access network node may receive the handover request message comprising a SRVCC operation possible indication from the second mobility management function.

At block 704, the access network node may trigger SRVCC from the second system to a third system after the handover from the first system to the second system based on the SRVCC operation possible indication. The third system may be any suitable system such as GERAN or UTRAN or 3GPP2 1×CS, etc.

In an embodiment, the access network node may immediately trigger SRVCC from the second system to the third system after the handover from the first system to the second system based on the SRVCC operation possible indication.

In an embodiment, the first system is a fifth generation system (5GS), the second system is an evolved packet system (EPS), and the third system is a second generation system or a third generation system.

As described above, it is not enough for MME to play the pure Control Plan Relay role in the complete SRVCC scenarios across 2G/3G, 4G and 5G. In the above SRVCC case according to various embodiments, based on the source AMF's input from UE Registration and Subscription data from UDM, MME is able to include the SRVCC Operation Possible IE to eNB during the 5GS to EPS handover using N26 interface, so that the SRVCC can be immediately triggered after the 5GS to EPS handover using N26 interface. In other words, the SRVCC can be triggered before a subsequent TAU procedure.

In an embodiment, Table 7.3.1-1 of 3GPP TS 29.274 V17.1.1 may be amended as following. In an embodiment, the “MME_SRVCC” may be renamed to “MME” as MME will not be transparent anymore. The amended Table 7.3.1-1 may extend the description of the Additional MM context for SRVCC from the S3/S10/S16 to N26 in the FRR.

TABLE 7.3.1-1
Information Elements in a Forward Relocation Request

| | | | | |
|---|---|---|---|---|
| Additional MM | CO | This IE shall be sent by the source MME/S4-SGSN to the | Additional MM | 0 |
| context for | | target MME/S4-SGSN on the S3/S10/S16 interfaces if MS | context for | |
| SRVCC | | Classmark2, MS Classmark3 and the Supported Codec | SRVCC | |
| | | are available in the source MME/S4-SGSN, or by the | | |
| | | source AMF to the target MME_SRVCC on the N26 | | |
| | | interface if MS Classmark2/3 and the Supported Codec are | | |
| | | available in the source AMF. | | |

In an embodiment, Table 6.1.6.2.4-1 of 3GPP TS 29.503 V17.2.0 may be amended as following. For example, besides the STN-SR and C-MSISDN which are defined for 5G SRVCC, Table 6.1.6.2.4-1 also introduces new “4gstnSr” and “4gcMsisdn”. Therefore AMF is aware of UE's 4G SRVCC subscription data. For example, this may be crucial for operators that treat 5G SRVCC as a value-added service.

TABLE 6.1.6.2.4-1
Definition of type AccessAndMobilitySubscriptionData

| | | | | |
|---|---|---|---|---|
| stnSr | StnSr | O | 0 . . . 1 | This IE shall be present if the UE is subscribed to 5G |
| | | | | SRVCC, |
| | | | | When present, it indicates the STN-SR (Session |
| | | | | Transfer Number for SRVCC) of the UE. |
| cMsisdn | CMsisdn | O | 0 . . . 1 | This IE shall be present if the UE is subscribed to 5G |
| | | | | SRVCC. |
| | | | | When present, it indicates the C-MSISDN |
| | | | | (Correlation MSISDN) of the UE. |
| 4gstnSr | 4gStnSr | O | 0 . . . 1 | This IE shall be present if the UE is subscribed to 4G |
| | | | | SRVCC, |
| | | | | When present, it indicates the STN-SR (Session |
| | | | | Transfer Number for SRVCC) of the UE. AMF can |
| | | | | inform MME UE has 4G SRVCC capability via the |
| | | | | FRR |
| 4gcMsisdn | 4gCMsisdn | O | 0 . . . 1 | This IE shall be present if the UE is subscribed to 4G |
| | | | | SRVCC. |
| | | | | When present, it indicates the C-MSISDN |
| | | | | (Correlation MSISDN) of the UE. |
| | | | | AMF can inform MME UE has 4G SRVCC capability |
| | | | | via the FRR |

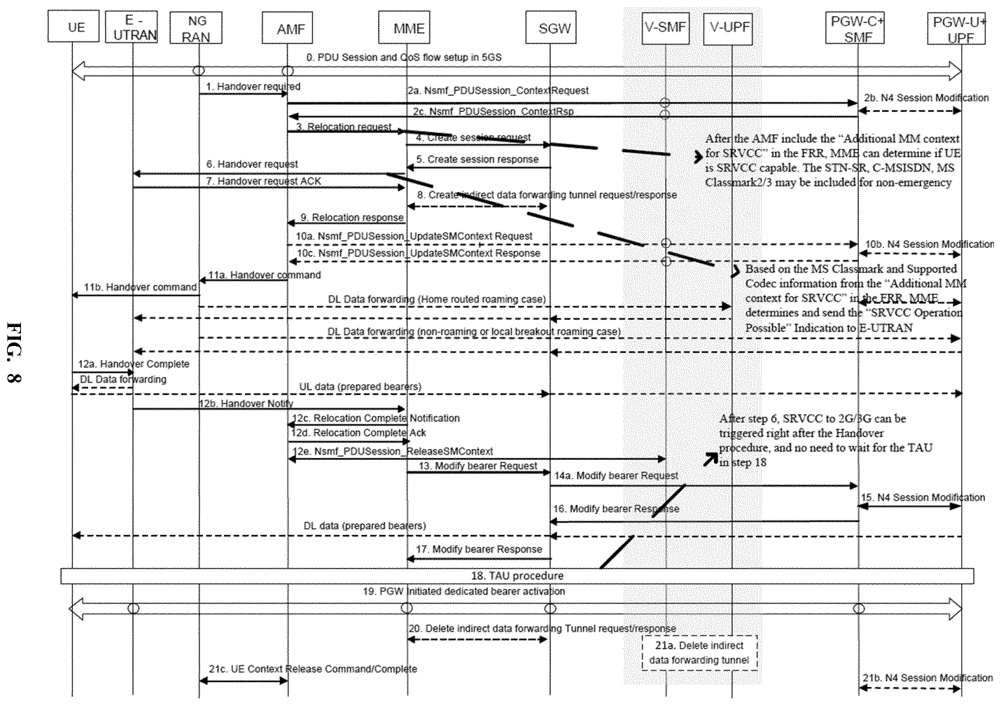

FIG. 8 shows a flowchart of 5GS to EPS handover using N26 interface with enhancements for SRVCC according to an embodiment of the present disclosure. Supposing UE supports SRVCC capability, e.g., MS Classmarks and Supported Codec Lists. Network supports SRVCC capability, e.g., no AMF and MME local restrictions. UE subscribes to the 4G SRVCC service, and AMF already retrieves the STN-SR and C-MSISDN from UDM in the previous Registration procedure.

Prior to the step 3 of FIG. 8, AMF already gets UE capability and its SRVCC subscription from UDM, so AMF can include the right MS Classmark2/3 (if GERAN or UTRAN access, or both are supported) and Supported Codec information in the IE Additional MM context for SRVCC of the FRR. Note, either MS Classmark2 or Classmark3 shall be explicitly mentioned in the Table 7.3.1-1 Information Elements in a FRR of 3GPP TS 29.274 V17.1.1.

At step 3 of FIG. 8, the AMF sends a Forward Relocation Request (FRR) as in step 3 in clause 5.5.1.2.2 (S1-based handover, normal) in 3GPP TS 23.401 V17.0.0, with the following modifications and clarifications:
Parameter “Return preferred” may be included. Return preferred is an optional indication by the MME of a preferred return of the UE to the 5GS PLMN at a later access change to a 5GS shared network. An MME may use this information as specified by 3GPP TS 23.501 V17.0.0.
The Serving gateway (SGW) address and TEID (Tunnel End Point Identifier) for both the control-plane or EPS bearers in the message are such that target MME selects a new SGW.
The AMF determines, based on configuration and the Direct Forwarding Path Availability, the Direct Forwarding Flag to inform the target MME whether direct data forwarding is applicable.
The AMF includes the mapped SM (Session Management) EPS UE Contexts for PDU (Protocol Data Unit) Sessions with and without active UP (user plane) connections.
Subject to operator policy if the secondary RAT access restriction condition is the same for EPS and 5GS, the AMF may set EPS secondary RAT access restriction condition based on the UE's subscription data.
AMF include the Additional MM context for SRVCC in the FRR, so MME can determine if UE is SRVCC capable. The STN-SR, C-MSISDN, MS Classmark2/3 may be included for non-emergency

Since AMF includes the Additional MM context for SRFVCC in the FRR at step 3 of FIG. 8, thus MME has knowledge whether UE is SRVCC capable based on the Additional MM context for SRFVCC. For example, based on the MS Classmark and Supported Codec information from the Additional MM context for SRVCC in the step 3 of FIG. 8, MME determines and send the SRVCC Operation Possible indication to the E-UTRAN. Thus MME can send a handover request including a SRVCC Operation Possible indication to E-UTRAN at step 6 of FIG. 8 during the handover procedure. After step 6 of FIG. 8, SRVCC to 2G/3G can be triggered right after the handover procedure while UE is still in the connected mode, and no need to wait for the TAU in step 19 of FIG. 8.

Embodiments herein may provide many advantages, of which a non-exhaustive list of examples follows. In some embodiments herein, it proposed a solution for the case of 5G to 4G Handover and then 4G to 2G/3G SRVCC. This user case is missed in 3GPP TS 23.216 V16.4.0. In some embodiments herein, the new IEs “4gStnSr” and “4gcMsisdn” are added in the section 6.1.6 Data Model of 3GPP TS 29.503 V17.2.0 which can be used for the proposed solution. In some embodiments herein, the MS Classmark3 and Supported Codec List, indicating GERAN access is supported by UE, can be sent in the FRR from AMF to MME, which can be used in some SRVCC cases. In some embodiments herein, the proposed solution extends the user case of SRVCC in which UE moves in this way: 5G->4G(Handover)->2G/3G(SRVCC). In some embodiments herein, the proposed solution can save the SRVCC procedure time since the SRVCC procedure can be immediately performed after the handover has completed. The embodiments herein are not limited to the features and advantages mentioned above. A person skilled in the art will recognize additional features and advantages upon reading the following detailed description.

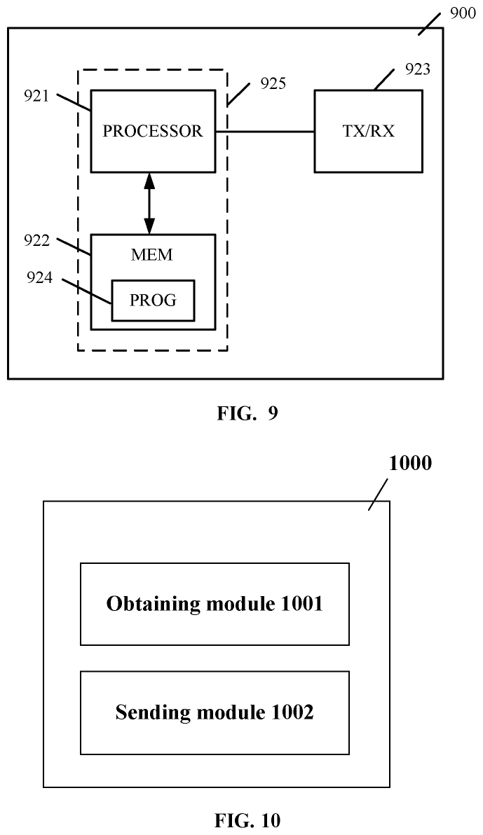

FIG. 9 is a block diagram showing an apparatus suitable for practicing some embodiments of the disclosure. For example, any one of the first mobility management function, the second mobility management function, or the access network node described above may be implemented as or through the apparatus 900.

The apparatus 900 comprises at least one processor 921, such as a digital processor (DP), and at least one memory (MEM) 922 coupled to the processor 921. The apparatus 900 may further comprise a transmitter TX and receiver RX 923 coupled to the processor 921. The MEM 922 stores a program (PROG) 924. The PROG 924 may include instructions that, when executed on the associated processor 921, enable the apparatus 900 to operate in accordance with the embodiments of the present disclosure. A combination of the at least one processor 921 and the at least one MEM 922 may form processing means 925 adapted to implement various embodiments of the present disclosure.

Various embodiments of the present disclosure may be implemented by computer program executable by one or more of the processor 921, software, firmware, hardware or in a combination thereof.

The MEM 922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 921 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first mobility management function, the memory 922 contains instructions executable by the processor 921, whereby the first mobility management function operates according to any of the methods related to the first mobility management function as described above.

In an embodiment where the apparatus is implemented as or at the second mobility management function, the memory 922 contains instructions executable by the processor 921, whereby the second mobility management function operates according to any of the methods related to the second mobility management function as described above.

In an embodiment where the apparatus is implemented as or at the access network node, the memory 922 contains instructions executable by the processor 921, whereby the access network node operates according to any of the methods related to the access network node as described above.

FIG. 10 is a block diagram showing a first mobility management function in a first system according to an embodiment of the disclosure. As shown, the first mobility management function 1000 comprises an obtaining module 1001 configured to obtain mobility management context for single radio voice call continuity (SRVCC). The first mobility management function 1000 further comprises a sending module 1002 configured to send a forward relocation request to a second mobility management function in a second system during a handover from the first system to the second system. The forward relocation request comprises mobility management context for the SRVCC.

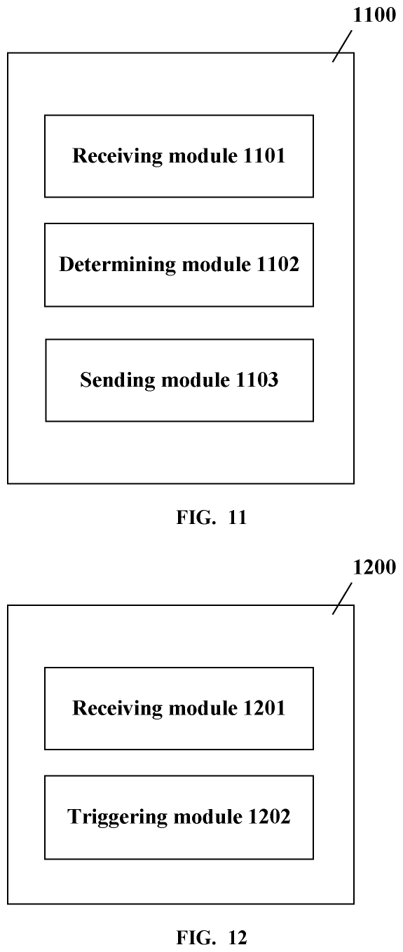

FIG. 11 is a block diagram showing a second mobility management function in a second system according to an embodiment of the disclosure. As shown, the second mobility management function 1100 comprises a receiving module 1101 configured to receive a forward relocation request from a first mobility management function in a first system during a handover from the first system to the second system. The forward relocation request comprises mobility management context for single radio voice call continuity (SRVCC). The second mobility management function 1100 further comprises a determining module 1102 configured to determine a SRVCC operation possible indication indicating whether both a user equipment and the second mobility management function are SRVCC-capable based at least partly on the mobility management context for SRVCC. The second mobility management function 1100 further comprises a sending module 1103 configured to send a handover request message comprising the SRVCC operation possible indication to an access network node in the second system.

FIG. 12 is a block diagram showing an access network node in a second system according to an embodiment of the disclosure. As shown, the access network node 1200 comprises a receiving module 1201 configured to receive a handover request message comprising a single radio voice call continuity (SRVCC) operation possible indication indicating whether both a user equipment and a second mobility management function in a second system are SRVCC-capable from the second mobility management function in the second system during a handover from a first system to the second system. The access network node 1200 further comprises a triggering module 1202 configured to trigger SRVCC from the second system to a third system after the handover from the first system to the second system based on the SRVCC operation possible indication.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first mobility management function, the second mobility management function, or the access network node may not need a fixed processor or memory, any computing resource and storage resource may be arranged from the first mobility management function, the second mobility management function, or the access network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-29. (canceled)

30. A method performed by a first mobility management function in a first system, comprising:
obtaining mobility management context for single radio voice call continuity (SRVCC); and
sending a forward relocation request to a second mobility management function in a second system during a handover from the first system to the second system, wherein the forward relocation request comprises mobility management context for the SRVCC.

31. The method according to claim 30, wherein the first system is a fifth generation system (5GS), and the second system is an evolved packet system (EPS).

32. The method according to claim 30, wherein the handover from the first system to the second system is 5GS to EPS handover using N26 interface.

33. The method according to claim 30, wherein the forward relocation request further comprises at least one of session transfer number for SRVCC (STN-SR) or correlation mobile subscriber integrated services digital network number (C-MSISDN).

34. The method according claim 30, wherein the forward relocation request further comprises at least one of session transfer number for SRVCC (STN-SR) or correlation mobile subscriber integrated services digital network number (C-MSISDN), when a user equipment related to the handover is subscribed to second system SRVCC.

35. The method according to claim 30, wherein the mobility management context for the SRVCC comprises information necessary for the second mobility management function to perform SRVCC.

36. The method according to claim 35, wherein the information comprises at least one mobile station classmark and/or supported codec list of a user equipment related to the handover.

37. The method according to claim 30, wherein the first mobility management function comprises an access and mobility function (AMF), and the second mobility management function comprises a mobility management entity (MME).

38. A method performed by a second mobility management function in a second system, comprising:
receiving a forward relocation request from a first mobility management function in a first system during a handover from the first system to the second system, wherein the forward relocation request comprises mobility management context for single radio voice call continuity (SRVCC);
determining a SRVCC operation possible indication indicating whether both a user equipment and the second mobility management function are SRVCC-capable based at least partly on the mobility management context for SRVCC; and
sending a handover request message comprising the SRVCC operation possible indication to an access network node in the second system.

39. The method according to claim 38, wherein the first system is a fifth generation system (5GS), and the second system is an evolved packet system (EPS).

40. The method according to claim 38, wherein the handover from the first system to the second system is 5GS to EPS handover using N26 interface.

41. The method according to claim 38, wherein the forward relocation request further comprises at least one of session transfer number for SRVCC (STN-SR) or correlation mobile subscriber integrated services digital network number (C-MSISDN).

42. The method according to claim 38, wherein the forward relocation request further comprises at least one of session transfer number for SRVCC (STN-SR) or correlation mobile subscriber integrated services digital network number (C-MSISDN), when a user equipment related to the handover is subscribed to second system SRVCC.

43. The method according to claim 38, wherein the mobility management context for the SRVCC comprises information necessary for the second mobility management function to perform SRVCC.

44. The method according to claim 43, wherein the information comprises at least one mobile station classmark and/or supported codec list of a user equipment related to the handover.

45. The method according to claim 38, wherein the first mobility management function comprises an access and mobility function (AMF), and the second mobility management function comprises a mobility management entity (MME).

46. A method performed by an access network node in a second system, comprising:
receiving a handover request message from a second mobility management function in the second system during a handover from a first system to the second system, wherein the handover request message comprises a single radio voice call continuity (SRVCC) operation possible indication indicating whether both a user equipment and the second mobility management function are SRVCC-capable; and
based on the SRVCC operation possible indication, triggering SRVCC from the second system to a third system after the handover from the first system to the second system.

47. The method according to claim 46, wherein triggering SRVCC from the second system to a third system after the handover from the first system to the second system comprises:
based on the SRVCC operation possible indication, immediately triggering SRVCC from the second system to the third system after the handover from the first system to the second system.

48. The method according to claim 46, wherein the first system is a fifth generation system (5GS), the second system is an evolved packet system (EPS), and the third system is a second generation system or a third generation system.

49. The method according to claim 46, wherein the handover from the first system to the second system is 5GS to EPS handover using N26 interface.

50. The method according to claim 46, wherein the second mobility management function comprises a mobility management entity (MME).

51. An apparatus configured to implement a first mobility management function in a first system, the apparatus comprising:
a processor; and
a memory coupled to the processor, said memory containing instructions executable by said processor, whereby said processor is operative to:
obtain mobility management context for single radio voice call continuity (SRVCC); and
send a forward relocation request from the first mobility management function to a second mobility management function in a second system during a handover from the first system to the second system, wherein the forward relocation request comprises mobility management context for the SRVCC.

52. An apparatus configured to implement a second mobility management function in a second system, the apparatus comprising:
a processor; and
a memory coupled to the processor, said memory containing instructions executable by said processor, whereby said processor is operative to:
receive a forward relocation request from a first mobility management function in a first system during a handover from the first system to the second system, wherein the forward relocation request comprises mobility management context for single radio voice call continuity (SRVCC);
based at least partly on the mobility management context for SRVCC, determine a SRVCC operation possible indication indicating whether both a user equipment and the second mobility management function are SRVCC-capable; and
send a handover request message comprising the SRVCC operation possible indication to an access network node in the second system.

53. An access network node in a second system, comprising:
a processor; and
a memory coupled to the processor, said memory containing instructions executable by said processor, whereby said access network node is operative to:
receive a handover request message from a second mobility management function in the second system during a handover from a first system to the second system, wherein the handover request message comprises a single radio voice call continuity (SRVCC) operation possible indication indicating whether both a user equipment and the second mobility management function are SRVCC-capable; and
based on the SRVCC operation possible indication, trigger SRVCC from the second system to a third system after the handover from the first system to the second system.
